(19) United States
(12) Patent Application Publication
(10) Pub. No.: US 2018/0150791 A1
(43) Pub. Date: May 31, 2018

(54) AUGMENTED REALITY-ASSISTED MODULAR SET-UP AND PRODUCT STOCKING SYSTEMS AND METHODS

(71) Applicant: Wal-Mart Stores, Inc., Bentonville, AR (US)

(72) Inventors: Ian Stansell, Bentonville, AR (US); Steven Lewis, Bentonville, AR (US)

(21) Appl. No.: 15/825,477

(22) Filed: Nov. 29, 2017

Related U.S. Application Data
(60) Provisional application No. 62/427,289, filed on Nov. 29, 2016.

(51) Int. Cl. G06Q 10/08; G06T 19/00; H04N 13/04; G06T 7/50

(52) U.S. Cl. CPC G06Q 10/087; G06T 7/50; H04N 13/0429; G06T 19/006

(57) ABSTRACT

Embodiments relate to augmented reality-assisted (AR-assisted) product modular arrangement systems and methods for setting up retail spaces and displays and arranging and stocking products thereon. The AR-assisted system can comprise an AR device, such as a headset, glasses, or mobile device, that guides a user through locating, setting up and arranging a retail display, such as a shelf, modular, rack or other physical area. In embodiments, the AR device can be used hands free. The AR device is in communication with a product database from which the AR device receives data, images and other information used in guiding the user through locating, setting up, arranging, auditing and other tasks involved in product modular arrangement.

### RELATED APPLICATION

The present application claims the benefit of U.S. Provisional Application No. 62/427,289 filed Nov. 29, 2016, which is hereby incorporated herein in its entirety by reference.

### TECHNICAL FIELD

The present disclosure relates generally to inventory management and more particularly to augmented reality-assisted systems and methods for setting up modulars and stocking products.

### BACKGROUND

Conventional processes for arranging shelves and store modulars is highly manual. They include locating the shelf or modular (sometimes on an empty or virtually empty floor when new stores are being set up); arranging the shelves or other hardware appropriately (i.e., ensuring that adjacent shelves are properly spaced); applying labels for the necessary products in specifically assigned places (i.e., measuring to ensure proper and even spacing); and placing the actual products in the assigned locations.

Store associates typically follow a hard copy, printed planogram. Planograms can be complex and require careful attention to detail. Stores want products placed in particular places and in neat and organized ways, and conventional manual processes can be challenging and error-prone.

### SUMMARY

Embodiments relate to systems and methods for augmented reality-assisted systems and methods for setting up modulars and stocking products.

In one embodiment, a system for arranging one or more modular components and one or more products on a product modular comprises a product database comprising product data of a plurality of products, the product data for each product comprising a plurality of concatenated fields comprising a product identification, a product image, a modular location, a product location, and a product arrangement and an augmented reality device in data communication with the product database and comprising at least one image sensor providing continuously updated image data, a geolocation system providing a continuously updated current location, and a display configured to display one or more prompts such that each of the one or more prompts appears associated with one or more detected objects.

The augmented reality device can be configured to receive the product data of the plurality of products from the product database, recognize a product identification and a current product location within the image data based on the product image, recognize a product label and a current label location within the image data based on the product identification, recognize a modular within the image data based on the current location and a feature of the modular, recognize a modular component and a current modular location within the image data based on a feature of the modular component, determine a target configuration of the recognized modular based on the product arrangement of each product in the plurality of products with a modular location corresponding to the recognized modular, and based on the target configuration, display a prompt indicating a target component location on the modular for the recognized modular component, display a prompt indicating a target product location on the recognized modular component for the recognized product, display a prompt indicating a target label location on the recognized modular component for the recognized label, display a prompt indicating an audit compliance result for the modular, the audit compliance result comprising a comparison of the current component location and the target component location, the current product location and the target product location and the current label location and the target label location.

In one embodiment, a product modular arrangement system comprises a product database comprising product data for a plurality of products, the product data for each product comprising a plurality of concatenated fields comprising a modular location, a product location, a product identification, a product arrangement, and a product image; and an augmented reality device comprising a display, a geolocation system and at least one image sensor and configured to receive the product data from the product database for at least one product to be arranged on a modular and to display on the display in turn a prompt of: an identification of the modular according to the modular location and the geolocation system, a location of at least one modular component on the modular according to the product location and the at least one image sensor, a product label image on a predetermined location on the at least one modular component according to the product location, the product identification and the at least one image sensor, the product image on a predetermined location of a product on the at least one modular component according to the product location, the product arrangement, the product identification and the at least one image sensor, and an audit compliance result before advancing to a next prompt according to the at least one image sensor and the product data.

In an embodiment, a method of arranging products on a modular comprises obtaining product data for a plurality of products, the product data for each product comprising a plurality of concatenated fields comprising a modular location, a product location, a product identification, a product arrangement, and a product image; providing an augmented reality device comprising the product data from the product database for at least one product to be arranged on a modular; and configuring the augmented reality device to display on the display in turn a prompt of: an identification of the modular according to the modular location and the geolocation system, a location of at least one modular component on the modular according to the product location and the at least one image sensor, a product label image on a predetermined location on the at least one modular component according to the product location, the product identification and the at least one image sensor, the product image on a predetermined location of a product on the at least one modular component according to the product location, the product arrangement, the product identification and the at least one image sensor, and an audit compliance result before advancing to a next prompt according to the at least one image sensor and the product data.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a block diagram of an augmented reality-assisted product modular arrangement system according to an embodiment.

FIG. 2A is a simplified diagram of a planogram according to an embodiment.

FIG. 2B is a set of product data database fields according to an embodiment.

FIG. 3 is a block diagram of an augmented reality device according to an embodiment.

FIG. 4 is flow chart of an augmented reality-assisted product modular arrangement method according to an embodiment.

FIG. 5A is a diagram of augmented reality device and modular according to an embodiment.

FIG. 5B is a diagram of augmented reality device and modular according to another embodiment.

FIG. 5C is a diagram of augmented reality device and modular according to another embodiment.

FIG. 6A is screen capture of a display of an augmented reality device according to an embodiment.

FIG. 6B is screen capture of a display of an augmented reality device according to an embodiment.

FIG. 6C is screen capture of a display of an augmented reality device according to an embodiment.

FIG. 6D is screen capture of a display of an augmented reality device according to an embodiment.

FIG. 7A is screen capture of a display of an augmented reality device according to an embodiment.

FIG. 7B is screen capture of a display of an augmented reality device according to an embodiment.

FIG. 7C is screen capture of a display of an augmented reality device according to an embodiment.

FIG. 8A is screen capture of a display of an augmented reality device according to an embodiment.

FIG. 8B is screen capture of a display of an augmented reality device according to an embodiment.

FIG. 9A is screen capture of a display of an augmented reality device according to an embodiment.

FIG. 9B is screen capture of a display of an augmented reality device according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Augmented reality (AR) is a real-time or live view of a real-world environment onto which are projected computer-generated elements (graphics, video, icons, images, highlighting, text, etc.) and that may also include sounds, touch or haptic elements, and other sensory inputs and effects. In these ways, AR augments or enhances a user's perception of reality.

This disclosure relates to an augmented reality-assisted (AR-assisted) product modular arrangement system for setting up retail spaces and displays and arranging and stocking products thereon. The AR-assisted system comprises an AR device, such as a headset, glasses, or mobile device, that uses one or more computer vision, object recognition and/or image processing techniques to guide a user through locating, setting up and arranging a retail display, such as a shelf, modular, rack or other physical area. In embodiments, the AR device can be used hands free. The AR device is in communication with a product database from which the AR device receives data, images and other information used in guiding the user through the locating, setting up, arranging, auditing and other tasks involved in product modular arrangement.

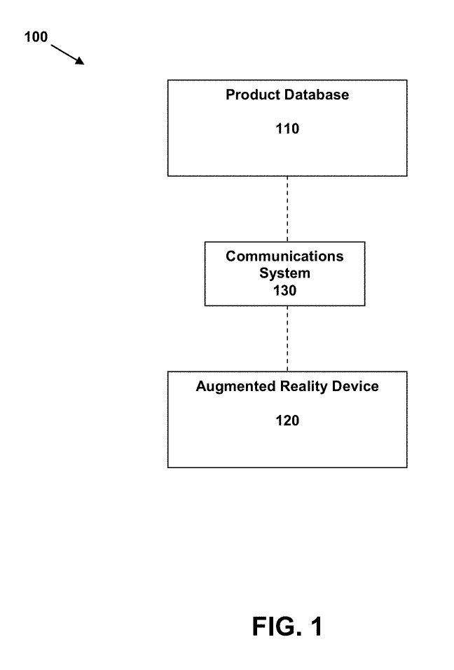

Referring to FIG. 1, an embodiment of an AR-assisted product modular arrangement system 100 is depicted. System 100 comprises at least one product database 110 and at least one AR device 120 communicatively coupled with one another by a communications system 130. In some embodiments, system 100 comprises a plurality of AR devices 120.

Product database 110 can comprise one or more databases. A database is a structured set of data held in a computer device, such as a server. Database software provides functionalities that allow building, modifying, accessing, and updating both databases and the underlying data. Databases and database software reside on database servers. Database servers are collections of hardware and software that provide storage and access to the database and enable execution of the database software.

In embodiments of system 100, the database servers for product databases 110 can be local (e.g., located in or associated with a particular retail store or location) or distributed (e.g., associated with one or more retail stores, locations or corporations), and/or the database servers or databases themselves can be cloud-based. As an example, product databases 110 accessed by or relied upon by various components of system 100 can be present on a single computing device in an embodiment. In other embodiments, one or more product databases 110 can be present on one or more database systems physically separate from one another. In one particular example, product databases 110 comprise one or more SQL or other relational databases.

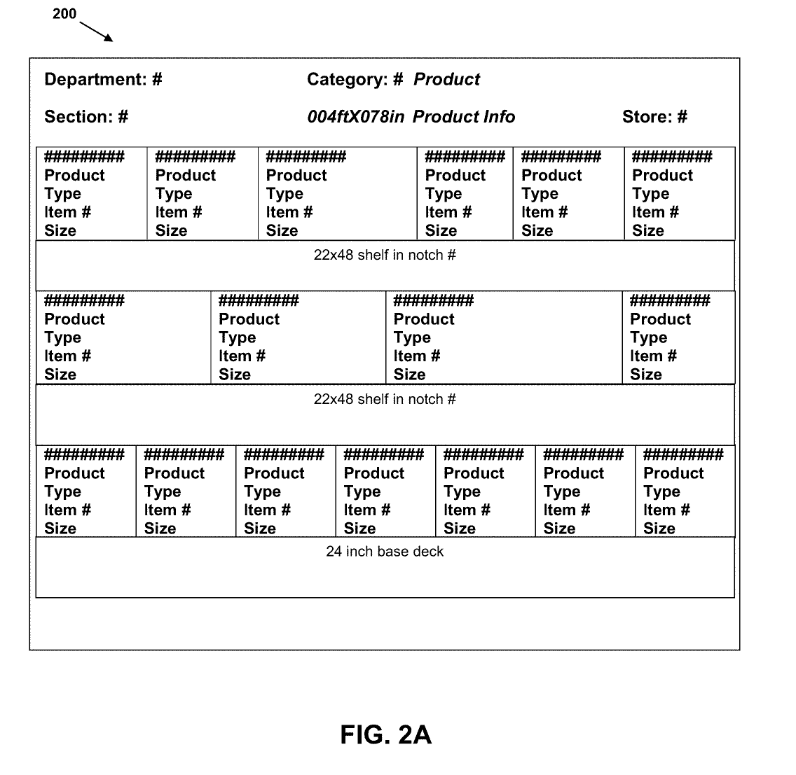

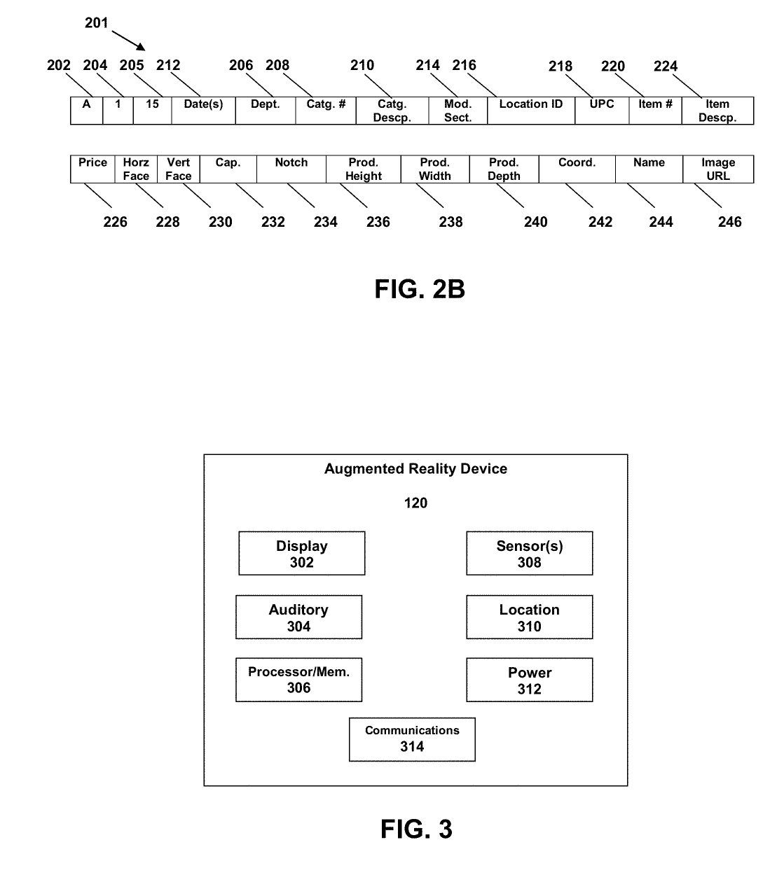

Product databases 110 comprise AR-optimized modular and product data. Conventionally, hardcopy planograms, such as the example planogram 200 depicted in FIG. 2A, are used to manually arrange modulars, modular components (e.g., shelves, hooks, rails, etc.), and products. In embodiments, system 100 uses similar backend planogram data, updated with additional fields and data and, generally, optimized for use by AR-assisted product modular arrangement system 100.

Referring to FIG. 2B, an example data set 201 for one product is shown. Though split into two lines because of page width, in general the data fields shown are concatenated in a single database row. In other embodiments, the order of fields can vary, fields can be omitted, and additional fields can be added. Generally, the fields can be grouped into several types of product data: modular location, product location, product identification, product arrangement, and product image.

Modular location data and fields include information to locate or identify the intended modular on which the product is to be placed and the types of products to be placed thereon. In FIG. 2B, this can include a store zone at 202, a store aisle at 204, and an aisle section at 205; a product department at 206, a product category at 208, and a product category description at 210. In other embodiments, the modular location data and fields can also include or instead comprise a zone, an aisle number, and a section number. Data set 201 also can include one or more dates at 212, which can include a date on which data set 201 is to be implemented, an expiration date, and/or some other relevant date.

Product location data and fields include information to properly place the product on the modular. In FIG. 2B, this can include Modular Section at 214 and Location Identification at 216.

Product identification data and fields include information about the particular product to be placed. In FIG. 2B, this can include the product Universal Product Code (UPC) at 218, an item number (which can be specific to the product, manufacturer and/or retailer) at 220, item description (such as a name of the product) at 224, and an item price at 226. In other embodiments, product identification data and fields can include a quick response (QR) code, electronic product code (EPC), or other machine-readable element, in addition to or instead of a product UPC.

Product arrangement data and fields include information about how the product is to be placed on the modular. In FIG. 2B, this can include a number of horizontal facings (how many of the product should be arranged horizontally in the assigned modular section) at 228, a number of vertical facings (how many of the product should be arranged vertically in the assigned modular section) at 230, product capacity (how many of the product can be stocked in the assigned modular section) at 232, a notch number (i.e., where the shelf or modular display component is mounted on the modular) at 234, a product height at 236, a product width at 238, and a product depth at 240, and a coordinate (which, together with the notch number, can be used by system 100 to confirm the modular section and will be discussed in more detail below) at 242.

Product image data and fields include information comprising or for locating an image of the product. In FIG. 2B, this can include a display name at 244 and an image Universal Resource Locator (URL) at 246. Providing a URL at 246 can enable faster location of the image and more responsive (i.e., faster) operation of AR device 120, and make it easier to obtain and/or update the image, including across system 100. In other embodiments, the product image URL at 246 can be replaced by an actual product image.

The data fields of data set 201 in FIG. 2B are but one example, and in other embodiments more, fewer and/or different fields can be included in data set 201. Data set 201 is associated with a single product to be placed in a specific location on an assigned modular arranged in an assigned area of a retail store. In embodiments, data set 201 is one row in product database 110, which further comprises tens, hundreds or thousands of data sets 201, each associated with a single product to be placed in a specific location on an assigned modular arranged in an assigned area of a retail store. The data structure of data set 201 and product database 110 is optimized for AR device 120 in system 100, providing a unique data structure particularly for AR device 120. As such, data set 201 comprises data different from, and in addition to, traditional planogram data, even though data set 201 can be based on a planogram-like implementation. In embodiments, the data structure of data set 201 can be further optimized for particular use cases or modes of system 100, which can include competitive or gamification modes to increase user engagement, speed and/or accuracy; stocking level or other auditing; product location assistance; and others.

In embodiments, system 100 can comprise additional databases (and/or product databases 110 can include additional types of data) to support operation of system 100. For example, in one embodiment system 100 further comprises a user database, enabling data about a user to be stored and used in system 100. User data can include identification data (e.g., an employee name and/or badge number), performance data (e.g., historical data from previous uses of AR device 120), user preferences (e.g., whether visual, audio and/or haptic feedback is preferred in various instances; selected tones; music or other information, such as may be associated with competitive or gamification modes), and other data. Still other databases can be used in or accessed by components of system 100 in various embodiments.

Referring to FIG. 3, AR device 120 can comprise one or more of a headset, goggles, glasses, wearable device (e.g., a smartwatch, hat, helmet, armband, smart-garment such as a vest or jacket), smartphone, or other device via which a user can interact with system 100 visually, audibly and/or haptically. AR device 120 can comprise one of a number of commercially available devices such as a GOOGLE TANGO phone, a MICROSOFT HOLOLENS, an OCULUS RIFT, or other similar device. AR device 120 can further comprise one or more software engines, such as applications providing specific configurations described herein.

AR device 120 is configured to project images and other information onto a user's field of view via AR device 120, thereby providing an “augmented” view of a real setting, or reality. In operation, AR device 120 uses one or more computer vision, object recognition and/or image processing techniques to recognize real-world objects in a view and augment the view with computer-generated objects in ways that provide meaningful and helpful information to the user. In examples used herein throughout, AR device 120 comprises a set of goggles, though the same or a similar augmented view can be produced by others of the aforementioned or other devices, such that the goggles example used herein is but one nonlimiting example used simply for convenience herein. Regardless of its particular form or configuration, AR device 120 comprises a display 302 via which a user can view information. In the goggles example embodiment, the inside surface of the goggles forms at least part of display 302.

In embodiments, AR device 120 comprises an auditory output component 304, such as one or more of headphones, a speaker, or other device configured to provide audible information and feedback to a user, and sensors, vibration motors or actuators, and/or other components configured to provide haptic feedback to a user. AR device 120 further comprises a processor and memory 306 configured to process and store data and information; one or more sensors 308 (e.g., an image sensor, a gyroscope, an accelerometer, a depth sensor) configured to provide information to AR device 120; a geolocation system 310 (e.g., GPS and/or other sensors, beacons, or microlocation apparatuses) configured to enable AR device 120 to determine its location and the location of other objects, such as modulars; a power source 312 (e.g., a replaceable or rechargeable battery); and communications circuitry 314. Communications circuitry 314 can be wireless (e.g., WIFI, Bluetooth, near-field communications—NFC, cellular) or wired (e.g., via USB, FireWire, Thunderbolt) in various embodiments, such that AR device 120 can be communicatively coupled with product database 110 via communications system 130.

Referring again to FIG. 1, communications system 130 can provide a communicative coupling between product database 110 and AR device 120. In some embodiments, communications system 130 can provide a communicative coupling between two or more AR devices 120 in system 100. Communications system 130 can comprise a wired, wireless or hybrid communication system. Wireless and wired communications schemes can include those previously mentioned with respect to AR device 120. In some embodiments, however, cellular communications may not be feasible or available, as coverage can vary or not exist within some structures, including some retail environments. Communications system 130 can comprise a direct or indirect connection scheme in embodiments. For example, communications system 130 can comprise “hopping,” collector, or other indirect connection schemes in which communications are passed from one or more AR devices 120 to one or more intermediary devices and then to product database 110. Those of skill in the art will appreciate that a wide variety of ways of providing communications between and amongst devices in system 100 can be implemented in embodiments.

Here and elsewhere, AR device 120 relies on image recognition techniques and data set 201 to guide users through modular set-up, label placement, product arrangement, and auditing. Image recognition is the process of identifying an object or feature in a digital image, which can be a still image or video. In practice, and in embodiments discussed herein, system 100 comprises and applies image recognition algorithms to images obtained via one or more sensors 308 of AR device 120. These algorithms can relate to optical character recognition (OCR); pattern, gradient, cross-correlation or other image feature matching; image recognition (similar to face recognition); and other image recognition techniques. In some embodiments of system 100, more than one algorithm can be applied by system 100 (e.g., AR device 120) and/or an algorithm can be optimized for particular image recognition techniques that are applicable to a particular use case of system 100. In still other embodiments, system 100 can apply machine learning techniques to continue to optimize the one or more algorithms in order to improve system performance.

In addition to detecting objects of interest, image recognition techniques can be used by AR device 120 to appropriately position marks or other indicators in the appropriate context on a user's display. As described herein, AR device 120 can present graphical indicators to the user such that they appear to be on, at, or overlaid on various physical objects. Such marks or other indicators can move on the display relative to the movement of the image sensor such that the marks or other indicators appear to float in place. In embodiments, image recognition and overlay techniques can be implemented based on location-based augmented reality software development kits (SDKs) or libraries known in the art, such as Wikitude, ARToolKit, or Vuforia. AR device 120 can use image recognition and overlay techniques to identify an object, location, or position, and update display 302 such that images or other marks are overlaid or placed in a position on, near, around, or otherwise associated with a recognized object or location.

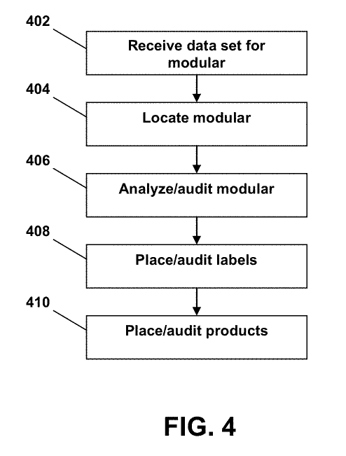

In operation, and referring to FIG. 4, AR device 120 communicates with product database 110 via communications system 130 to receive data set 201 for a particular modular or other area to be stocked, at 402. In one embodiment, this can be carried out in one of at least two ways: (1) data set 201 for a particular modular is sent to AR device 120, and a user of AR device 120 then locates the particular modular, at 404; or (2) a user identifies a particular modular to be stocked, such as by walking up to it and seeing it needs stocking, and interacts with AR device 120 to obtain the relevant data set 201, in which case activities 402 and 404 in FIG. 4 are reversed. In embodiments, the received data set 201 can be limited based on store, location, date, or other factors in order to increase performance in data transfer and execution by limiting the universe of options examined by image recognition algorithms.

In one embodiment associated with (1), locating the modular (404) can comprise receiving audible and/or visual prompts from AR device 102 directing the user to a particular location. The audible and/or visual prompts can be similar to those provided in navigation systems, a set of AR superimposed arrows or guides for the user to follow, or some other type of prompt that guides a user through the store or space and to the desired modular. In another embodiment, AR device 120 can audibly and/or visually provide department, zone, aisle, section and/or other information that enables a user to self-navigate and identify the desired modular.

In the case of (2), locating the modular (404) can include the user providing input to AR device 120 in order to request and receive the relevant data. This input can comprise verbal input (e.g., saying a department, zone, aisle or section, or other identifying information), visual input (e.g., standing in front of a desired modular and “scanning” markers or other identifying information on the modular by AR device 120, using artificial intelligence to “read” information on product packaging or identify a type of product being viewed), or geolocation input (e.g., identifying a current location of AR device 120 by geolocation system 310, and identifying the desired modular from possible modulars at that location or by determining a direction of vision of the user of AR device 120). In some embodiments, a combination of these inputs can be used. For example, a user can verbally input a department, then AR device 120 can visually scan a modular for markers or other identifiers to identify the desired modular.

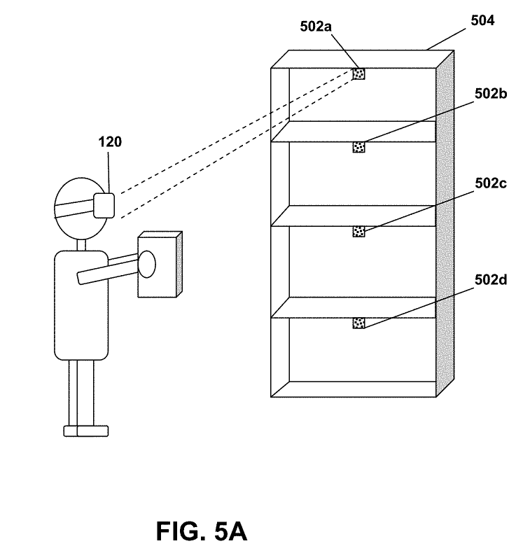

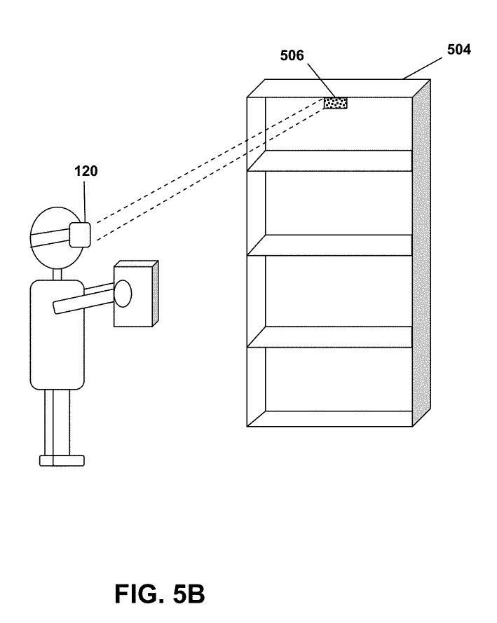

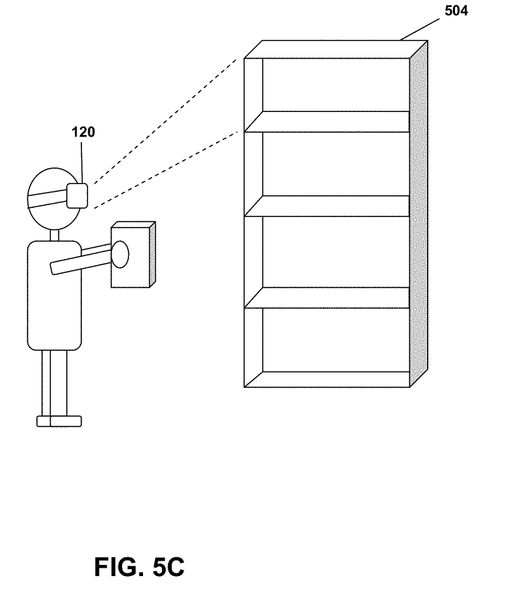

Use of markers is optional but can be helpful in some embodiments. Markers can be used to provide identifying information that can be machine-read by AR device 120. The identifying information can comprise alpha-numerics, machine-readable codes (e.g., QR code, RFID, bar code), or some other identifiers. In one embodiment and referring to FIG. 5A, multiple markers 502a, 502b, 502c, 502d can be used, such as one for each shelf. Though depicted on the top of each shelf area, each marker 502a-d could instead be mounted on the bottom of each shelf or somewhere else on modular 504.

In the embodiment of FIG. 5B, a single marker 506 is used. Marker 506 can be larger than markers 502a-d used in multiple marker configurations and can enable AR device 120 to use extended image tracking to identify modular 504 and its components. Extended image tracking involves tracking a degree of persistence once a marker has been detected. This allows inference of the marker using information from the environment or device sensors. Thus, in operation, AR device 120 is configured to detect marker 506 and track a degree of persistence of marker 506, using information such as elements of modular 504 itself, products already placed on modular 504, and other environmental information. This same approach can be implemented in embodiments in which multiple markers are used (see, e.g., FIG. 5A) or those in which no markers are used (discussed below with respect to FIG. 5C). In part because of this approach used by AR device 120, the particular location and configuration of marker 506 can vary in embodiments, and like markers 502a-d, marker 506 can comprise alpha-numerics, machine-readable code, or other information that can be “seen” and processed by AR device 120.

In yet another embodiment depicted in FIG. 5C, no markers are used. Instead, a first “benchmark” product can be placed on modular 504 in the correct position as guided by AR device 120, then AR device 120 can use the benchmark item to guide placement and arrangement of other products on modular 504.

In an alternative embodiment of a markerless approach like the one depicted in FIG. 5C, a depth sensor can be used to determine a current placement of products or modular components on modular 504. For example, the image sensor data can be used to detect an edge or lip of a modular component such as a shelf, and depth sensor data can be used to calculate the distance between shelves. In another example, depth sensor data can be used to determine how many additional products can be placed in a given position on modular 504.

In still other embodiments, combinations of the marker and markerless approaches of FIGS. 5A-5C can be used. For example, system 100 can use the single marker approach of FIG. 5B, then transition to the markerless approach of FIG. 5C once a first product is correctly placed.

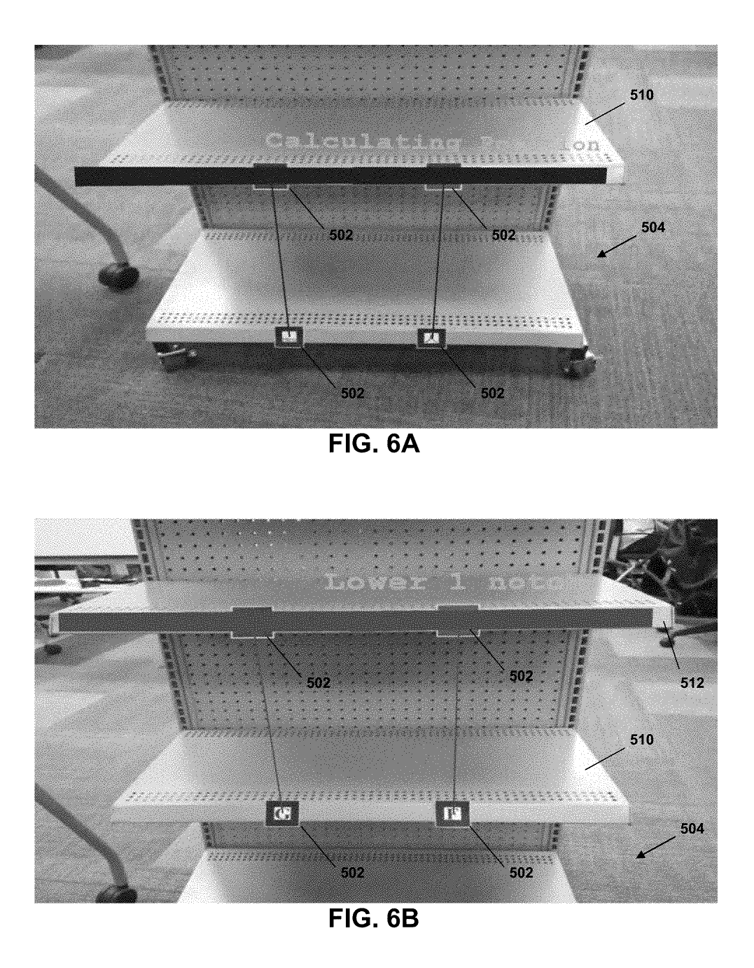

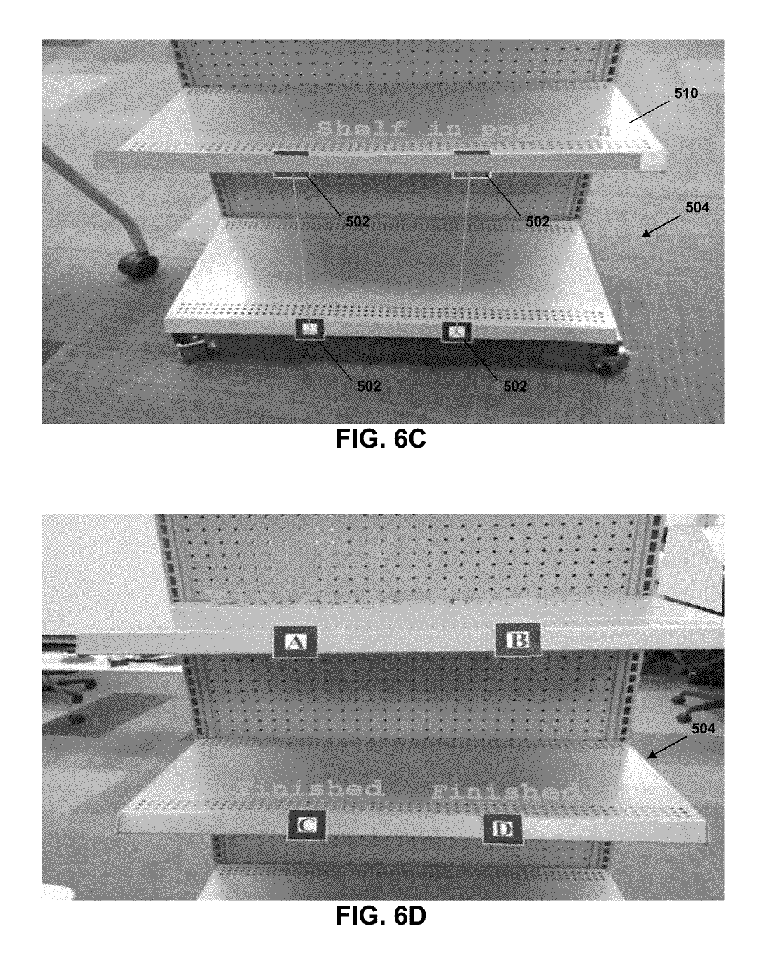

Once the desired modular is located at 404, the modular is analyzed at 406. This analysis is done to set up the modular itself, or audit or confirm that the modular is correctly set up. This activity can use marker or markerless approaches, as discussed above. FIGS. 6A-6C are screen shots of display 302 of AR device 120 as seen by a user during operation. In FIG. 6A, AR device 120 uses markers 502 to determine the location of shelf 510 of modular 504. In FIG. 6C, AR device 120 determines that shelf 510 is not property positioned with respect to shelf 512 above and instructs the user via visual instructions (though audible, haptic and/or other prompts also can be provided) to lower shelf 510 one notch on modular 504. In FIG. 6B, AR device 120 confirms that shelf 510 is now properly positioned. Once this process is repeated for each shelf or other component of modular 504, AR device 120 can audit the completed modular to confirm that all components are properly positioned according to product data 201, as shown in FIG. 6D.

Auditing is discussed in several contexts herein and generally comprises review of a completed task by system 100 to determine whether the task has been completed correctly. If the task is found to be completed correctly, AR device 120 can provide positive feedback (visually, audibly and/or haptically) and advance the user to a next task. If the task is found to be completed incorrectly, AR device 120 can guide a user through correction as is illustrated in FIGS. 6A-6C.

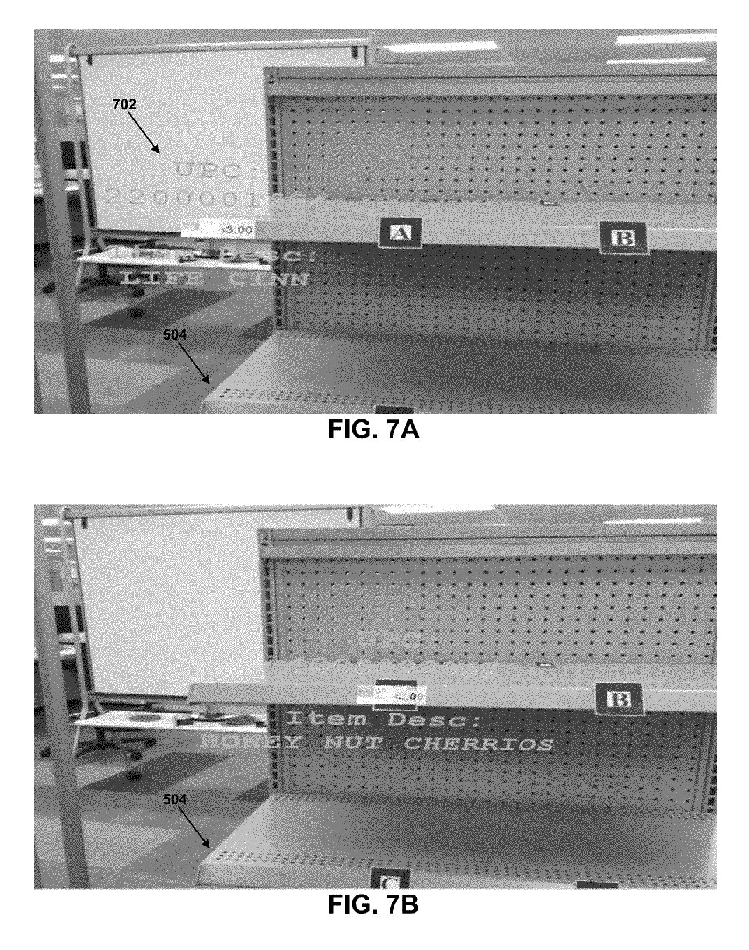

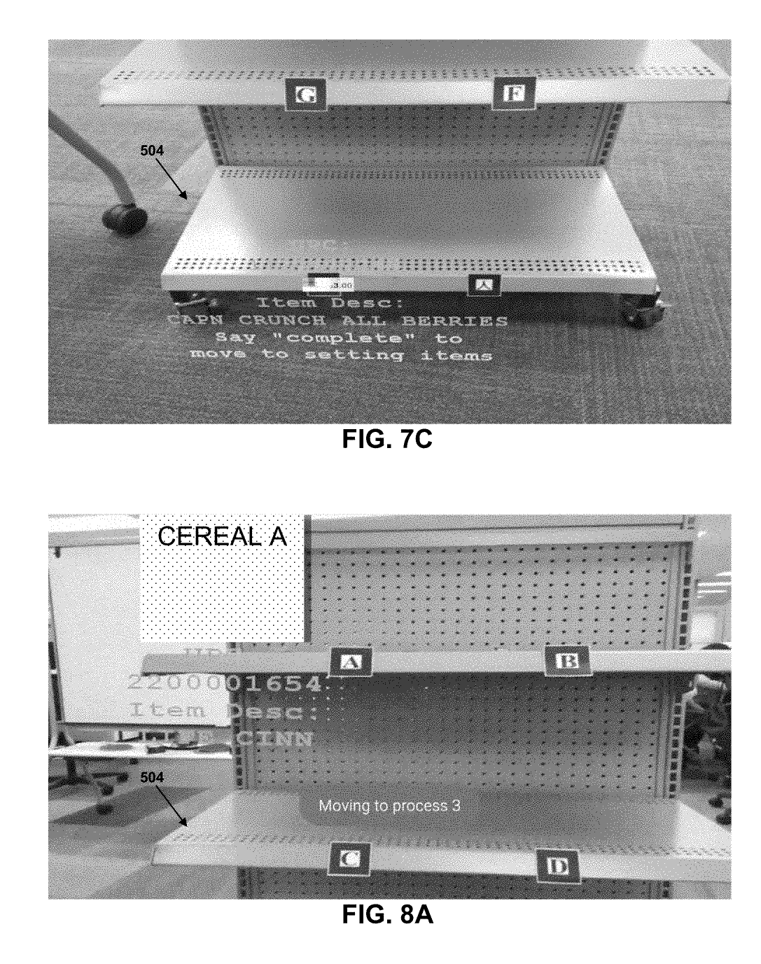

AR device 120 then prompts the user to advance to arranging product labels on modular 504, as 408. An embodiment of this process is depicted in FIGS. 7A-7C. In FIG. 7A, AR device 120 directs a user to place a label with a particular UPC at a particular location on modular 504 by overlaying an image 702 of the label and additional information on the shelf. In FIG. 7B, system 100 advances to the next label. For label placement and other processes, AR device 120 can advance from item to item based on visual confirmation by AR device 120, by the user providing a verbal prompt (e.g., “Next label” or “Complete”), using gesture recognition as the user places each label or item, or by some other prompt. The label placement process can continue, moving left to right across each shelf or zig-zagging (i.e., moving left to right across a first shelf, then moving right to left across the next shelf, then moving left to right across the third shelf, etc.). When all of the labels are placed, AR device 120 can visually audit all of the placed labels on modular 504 before prompting a user to confirm that label placement is complete, as depicted in FIG. 7C, before moving on to product placement at 410. In embodiments, AR device 120 can prompt the user to perform product placement at 410 before, or concurrently with arranging product labels at 408.

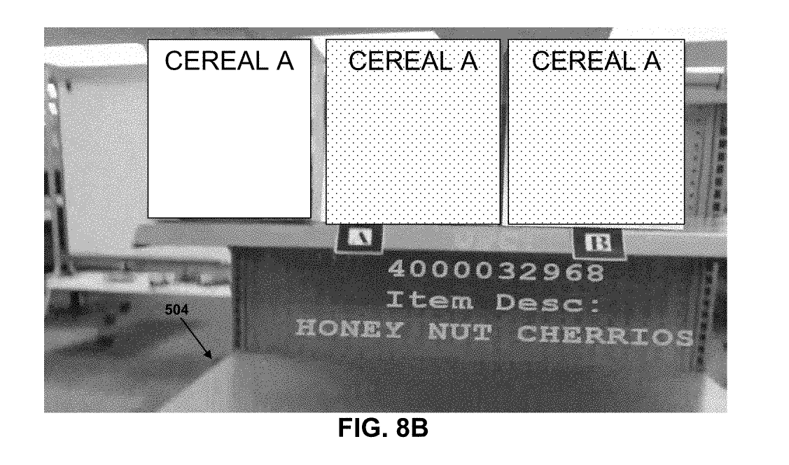

AR device 120 guides the user through product placement similar to label placement, and an example is depicted in FIGS. 8A and 8B. In FIG. 8A, AR device confirms to the user that it is advancing to the next process (“Process 3”), then overlays an image of a product and related information on the proper location on modular 504 via display 302. The stippling in “Cereal A” in FIG. 8A represents an overlaid image, whereas the solid white box in FIG. 8B represents an actual placed product corresponding to the image. As each product is placed, AR device 120 can provide visual, audible and/or haptic prompts to the user until all products are placed. As for the labels, AR device 120 can visually audit all of the placed products on modular 504 before prompting a user to confirm that the process is complete.

AR device 120 can identify products to be placed in a variety of ways. In FIGS. 8A and 8B, AR device 120 can simply advance left-to-right, etc., across and through the modular, such that the user must locate the next product according to the predefined list or arrangement used by AR device 120 according to product data 201. In another embodiment, a user can select a product to place and “show” the product to AR device 120 such that AR device 120 can identify the modular location associated with that product. For example, and adapting the example of FIGS. 8A and 8B, FIG. 8A can be preceded by the user picking up a box of CEREAL A from a pallet, viewing it via display 302 of AR device 120 such that AR device 120 can use image recognition to identify the product or read a bar code or other information to identify the product.

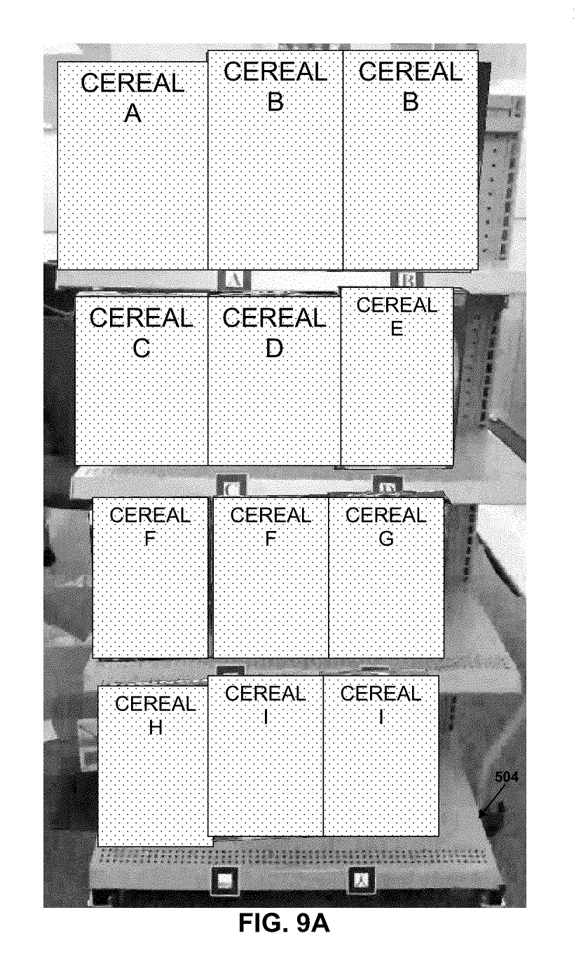

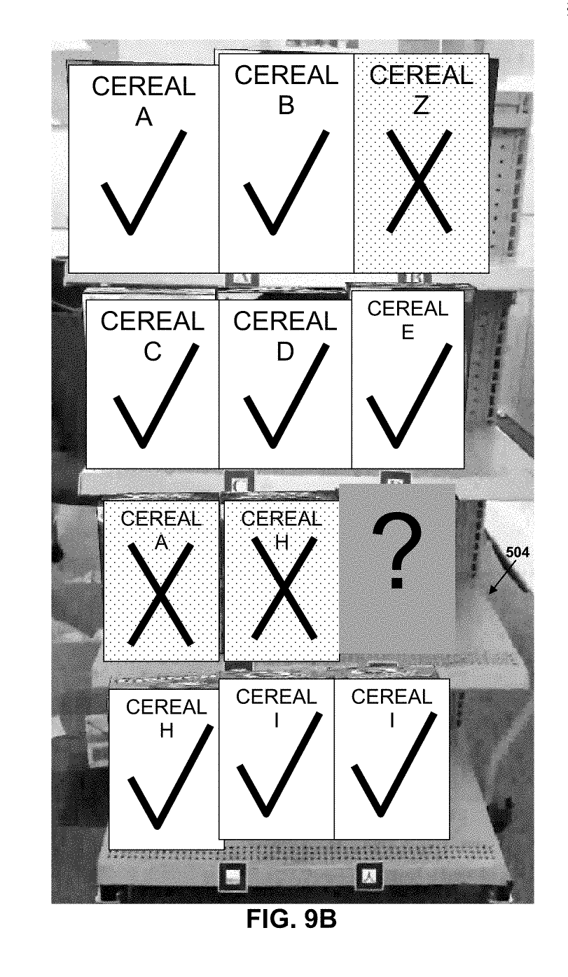

In another embodiment, AR device 120 can display to a user images of all of the products on modular 504 at the same time, such as is depicted in FIG. 9A. The user then can pick and choose which products to arrange in which order, an approach that can be more convenient in some situations and/or to some users. In operation, AR device 120 can orient and reorient the product images on display 302 according to the user's position and viewing angle relative to modular 504, making it easy for the user to move around (as is customary when carrying out stocking tasks).

Here and in other contexts, AR device 120 can use image recognition to identify products and carry out other tasks, including auditing individual products as they are placed and entire modulars once components (e.g., shelves or hooks) and products are arranged thereon. Conventionally, image recognition can be slow and cumbersome because of the vast number of images that must be reviewed and compared. In embodiments of system 100, processing techniques can be uses to make image recognition faster and easier. For example, if AR device 120 had identified that a user is working in a particular department, such as from product data 201, geolocation of AR device 120 and/or modular 504, or in some other way, AR device 120 can request or system 100/product database 110 can push only data and information, including images, for products in that department (or associated with a particular modular or zone, etc.). In this way, AR device 120 has access to image and other data most likely to be related to the task at hand without being burdened by other image data for another department or area that is not needed.

When viewing images, AR device 120 can utilize OCR and other image recognition techniques, as mentioned above. In some embodiments, AR device 120 can be trained to recognize objects like labels as a whole, rather than by reading a bar code or other information contained on the label. In other words, AR device 120 can view a label in its entirety as a image such that that image can be recognized and compared. These features enable AR device 120 to operate as depicted in FIG. 9B, in which AR device 120 recognizes and audits each product and product area and provides visual feedback to a user with respect to which products are placed correctly, or incorrectly, remain to be placed, or for which AR device 120 needs additional information or cannot recognize the image. For example, as depicted in FIG. 9B a check mark or other symbol with a positive connotation can be overlaid by AR device 120 (via display 302) when a product is properly placed on modular 504. An X or other symbol that has a negative implication can be overlaid by AR device 120 when the wrong product is placed in an area of modular 504. In addition to an X or other symbol, AR device 120 can overlay a symbol indicating how one or more products should be moved to bring the correct product into an area for modular 504. For example, an arrow can indicate a direction to move a product that is placed in the wrong area on module 504.

A question mark or other symbol with an uncertain connotation can be overlaid by AR device 120 on an empty modular area where a product is yet to be placed, or for which additional information is needed. In these situations, AR device 120 may be unable to recognize an item based on the information available locally at AR device 120 or in product databases 110, such that a more in-depth search may be conducted within product databases 110 or beyond (e.g., in additional databases or on the internet). In some situations, an image for the product or item may not yet exist in product databases 110, such that a user could be prompted by AR device 120 to take a photo of the product or item, via AR device 120 or another device, and submit the photo to product databases 110.

As a user arranges and rearranges the products on modular 504, AR device 120 updates the feedback in real time. In embodiments, the marks and other indicators can include colors, pictures, animations, or other features to increase visual interest and feedback (e.g., the checkmarks can be green, the Xs can be red, the question marks can be blue), or other shapes or symbols can be used. Audible and/or haptic feedback also can be provided in realtime to indicate whether products are correctly or incorrectly placed.

Thus, AR device 120 is able to apply image recognition techniques to individual components of an image, when that image is the real-world view of a user via AR device 120. In other words, each box of cereal in FIG. 9B is a component of the overall image of modular 504, the products arranged on modular 504, and the environment surrounding modular 504. The ability of AR device 120 to break down complex “images” in this way provides increased applications for AR device 120.

Therefore, there are several use cases for the AR system beyond item arrangement, including item location guidance, and product restocking. In one embodiment, the AR system can passively audit modulars as they are brought within the field of view of an associate, and alert the associate to modulars that are out of compliance, as well as guiding the associate to adjust the product arrangement as needed. The AR system also can be used in different modes, such as an associate mode generally discussed herein, and a customer mode, which could integrate with a shopping list, provide nutritional information, and otherwise assist a customer during a shopping experience.

To facilitate these and other cases, embodiments of system 100 can comprise or interact with other devices, systems and components, include handheld ring and other scanners and readers, point-of-sale (POS) systems, mobile phones and applications (“apps”), voice and video conferencing systems, and others. In some embodiments, system 100 can be used to arrange modulars and other components in a newly built store, such that micro-location systems can be particularly helpful. Such systems can include store-based readers to triangulate locations, ultra-frequency sound-based systems, and other micro-location or similar systems that can be used in areas in which traditional GPS and other systems may not be optimal or operational (e.g., inside large buildings or structures, particularly those built with metal roofs and other components.

As discussed herein, embodiments of system 100 are distinct from and advanced beyond systems that use AR to design spaces, as system 100 can instead assist with the highly complex and currently manual tasks related to building and executing arrangements in physical retail spaces. Instead of merely optimizing a theoretical design, system 100 is tied to real-world physical locations, dimensions and objects, requiring sophisticated location determination and awareness in real-time. Moreover, embodiments of system 100 can identify and process changing real-world conditions in order to assist users with desired tasks that relate to physical environments and objects therein.

In various embodiments, system 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but also to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In embodiments, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for arranging one or more modular components and one or more products on a product modular, the system comprising:
a product database comprising product data of a plurality of products, the product data for each product comprising a plurality of concatenated fields comprising a product identification, a product image, a modular location, a product location, and a product arrangement; and
an augmented reality device in data communication with the product database and comprising:
at least one image sensor providing continuously updated image data,
a geolocation system providing a continuously updated current location, and
a display configured to display one or more prompts such that each of the one or more prompts appears associated with one or more detected objects;
the augmented reality device configured to:
receive the product data of the plurality of products from the product database,
recognize a product identification and a current product location within the image data based on the product image,
recognize a product label and a current label location within the image data based on the product identification,
recognize a modular within the image data based on the current location and a feature of the modular,
recognize a modular component and a current modular location within the image data based on a feature of the modular component,
determine a target configuration of the recognized modular based on the product arrangement of each product in the plurality of products with a modular location corresponding to the recognized modular, and
based on the target configuration:
display a prompt indicating a target component location on the modular for the recognized modular component,
display a prompt indicating a target product location on the recognized modular component for the recognized product,
display a prompt indicating a target label location on the recognized modular component for the recognized label,
display a prompt indicating an audit compliance result for the modular, the audit compliance result comprising a comparison of the current component location and the target component location, the current product location and the target product location and the current label location and the target label location.

2. The system of claim 1, wherein the augmented reality device further comprises a depth sensor providing continuous depth data, and wherein the current location of the recognized modular component and the current location of the at least one product are also recognized based on the depth data.

3. The system of claim 1, wherein the augmented reality device comprises a hands-free device.

4. The system of claim 3, wherein the hands-free device comprises a wearable device.

5. The system of claim 4, wherein the wearable device comprises at least one of a headset, a smartwatch, glasses, goggles, hat, armband, or smart-garment.

6. The system of claim 1, wherein the augmented reality device comprises a smartphone.

7. The system of claim 1, wherein the modular location comprises a set of data comprising:
a department number, a category number, and a modular section; or
a zone, an aisle number, and a section number.

8. The system of claim 1, wherein the product location comprises a modular section and a location identification.

9. The system of claim 1, wherein the product identification comprises at least one of a machine-readable code, an item number, an item name or a price.

10. The system of claim 9, wherein the machine-readable code comprises at least one of a Universal Product Code (UPC), an electronic product code (EPC), or a quick response (QR) code.

11. The system of claim 1, wherein the product arrangement comprises a horizontal facings number, a vertical facings number, a capacity, a notch number, a product height, a product width, a product depth, and a coordinate.

12. The system of claim 1, wherein the product image comprises a product image Uniform Resource Locator (URL).

13. The system of claim 1, wherein the plurality of concatenated fields comprises a department number, a category number, a category description, a modular section, a location identification, a Universal Product Code (UPC), an item number, an item name, a price, a horizontal facings number, a vertical facings number, a capacity, a notch number, a product height, a product width, a product depth, a coordinate, and one of a product image or a product image URL.

14. The system of claim 1, wherein the at least one feature of the modular comprises at least one marker arranged on the modular, identifiable by the at least one image sensor, and used by the augmented reality device to determine at least one location on the modular.

15. The system of claim 14, wherein the modular component comprises a shelf, and wherein the at least one feature of the modular component comprises at least one marker arranged on the shelf

16. The system of claim 1, wherein the audit compliance result comprises at least one image indicating a least one of: a correctly placed product, an incorrectly placed product, a product yet to be placed, or a product for which the product image cannot be located in the product database.

17. The system of claim 1, wherein the display is configured to update the audit compliance result in real time as products are arranged on the modular.

18. The system of claim 1, wherein the product label image and the product image comprise augmented reality visual overlays on the modular.

19. The system of claim 1, wherein the augmented reality device further comprises a speaker configured to provide audible prompts and feedback.

20. A method of arranging products on a modular comprising:
obtaining product data for a plurality of products, the product data for each product comprising a plurality of concatenated fields comprising a modular location, a product location, a product identification, a product arrangement, and a product image;
providing an augmented reality device comprising the product data from the product database for at least one product to be arranged on a modular; and
configuring the augmented reality device to display on the display in turn a prompt of:
an identification of the modular according to the modular location and the geolocation system,
a location of at least one modular component on the modular according to the product location and the at least one image sensor,
a product label image on a predetermined location on the at least one modular component according to the product location, the product identification and the at least one image sensor,
the product image on a predetermined location of a product on the at least one modular component according to the product location, the product arrangement, the product identification and the at least one image sensor, and
an audit compliance result before advancing to a next prompt according to the at least one image sensor and the product data.

21. The method of claim 20, further comprising formulating the plurality of concatenated fields to comprise a department number, a category number, a category description, a modular section, a location identification, a machine-readable code, an item number, an item name, a price, a horizontal facings number, a vertical facings number, a capacity, a notch number, a product height, a product width, a product depth, a coordinate, and one of a product image or a product image URL.

22. The method of claim 21, wherein the machine-readable code comprises at least one of a Universal Product Code (UPC), an electronic product code (EPC), or a quick response (QR) code.

23. The method of claim 20, wherein configuring the augmented reality device further comprises configuring the augmented reality device to provide at least one of audible prompts or haptic prompts.

24. The method of claim 20, further comprising providing at least one marker recognizable by the augmented display device on the modular.
